(19) United States
(12) Patent Application Publication
(10) Pub. No.: US 2015/0025916 A1
(43) Pub. Date: Jan. 22, 2015

(54) IMPAIRED DRIVING PREVENTION

(71) Applicant: AmRide LLC, Rocky Hill, CT (US)

(72) Inventors: Rene Rodriguez, Hartford, CT (US); William S. Fish, JR., Marlborough, CT (US)

(21) Appl. No.: 14/333,629

(22) Filed: Jul. 17, 2014

Related U.S. Application Data
(60) Provisional application No. 61/847,167, filed on Jul. 17, 2013.

(51) Int. Cl. G06Q 50/26

(52) U.S. Cl. CPC G06Q 50/265; G06Q 40/08
USPC 705/4

(57) ABSTRACT

An aspect of impaired driving prevention services utilizes a method including registering a client for impaired driving prevention services. The impaired driving prevention services provide access to driver services for the client when the client is impaired. Agreement by the client to use the driver services when an impairment situation occurs is a condition of registration. The method also includes incorporating a benefit into an insurance policy of the registered client with respect to the impaired driving prevention services. The method also includes processing impaired driving prevention activities conducted between a driver service and the client, storing results of processed activities in a database record of the client, and reporting the results of the processed activities to an insurance provider that issued the insurance policy. A future benefit for the client is determined as a function of the results.

### CROSS-REFERENCE TO RELATED APPLICATION

This application claims the benefit of U.S. Provisional Application No. 61/847,167 filed Jul. 17, 2013 and entitled “Impaired Driving Prevention,” the content of which is incorporated herein by reference in its entirety.

### BACKGROUND

The present invention relates generally to data processing and, more particularly, to impaired driving prevention through an automated system that provides benefits to individuals and entities that utilize qualified driving services to prevent impaired driving of vehicles and, thus, minimize the risks otherwise associated with driving in an impaired condition or state.

Impaired driving can be caused by various factors, such as alcohol consumption, medical conditions, and lack of sleep, to name a few. Impairment may be characterized as any condition that may negatively impact a person's reflex abilities, motor control, vision, and/or mental acuity, to name a few. With respect to factors associated with alcohol consumption, currently, as a socially accepted practice, designated drivers of vehicles are encouraged to refrain from consuming alcohol when out with friends or family who have indicated an intention to consume alcohol. However, it can be difficult for some people to persuade a friend, colleague, or family member to abstain for an event, particularly when the event is widely associated with alcohol consumption (e.g., bars, weddings, holiday parties, sporting events, etc.).

In some instances, otherwise socially responsible individuals find themselves impaired without deliberate intention to become so (e.g., when someone is prescribed medication and does not appreciate the adverse effects of the medication and/or mixing substances with the medication).

As concerns about the prevalence of serious bodily injury or death, as well as vehicle and property damage due to impaired driving increase, law enforcement and government agencies are seeking new ways to reduce the incidences of impaired driving. With respect to alcohol consumption, e.g., agencies often rely more and more on establishments that serve alcohol to monitor their customers' alcohol consumption and take any necessary actions (e.g., refusing to serve or calling a taxi for the intoxicated customer). There is much inconsistency among establishments in the effectiveness and capabilities of customer- and consumption-monitoring of alcohol. As a result, many impaired individuals are able to access their vehicles and create an unsafe environment for themselves, their passengers, and all others on the road.

Further, individuals who may be impaired due to a temporary medical condition may not be receptive to abstaining from driving, particularly when a vehicle is needed to maintain a minimum quality of life.

What is needed, therefore, is a way to prevent or reduce impaired driving through an automated system that provides benefits to individuals and entities that utilize qualified driving services when an impairment issue is determined.

### SUMMARY

According to one embodiment of the present invention, a method is provided. The method includes registering a client for impaired driving prevention services. The impaired driving prevention services provide access to driver services for the client when the client is impaired. Agreement by the client to use the driver services when an impairment situation occurs is a condition of registration. The method also includes incorporating a benefit into an insurance policy of the registered client with respect to the impaired driving prevention services. The method further includes processing impaired driving prevention activities conducted between a driver service and the client, storing the results of processed activities in a database record of the client, and reporting the results of the processed activities to an insurance provider that issued the insurance policy. A future benefit for the client is determined as a function of the results.

According to another embodiment of the present invention, a system is provided. The system includes a computer processor and an application executable by the computer processor. The application is configured to implement a method. The method includes registering a client for impaired driving prevention services. The impaired driving prevention services provide access to driver services for the client when the client is impaired. The method also includes incorporating a benefit into an insurance policy of the client with respect to the impaired driving prevention services. The method further includes processing impaired driving prevention activities conducted between a driver service and the client, storing results of processed activities in a database record of the client, and reporting the results of the processed activities to an insurance provider that issued the insurance policy. A future benefit for the client is determined as a function of the results.

According to further embodiment of the present invention, a computer program product is provided. The computer program product includes a storage medium encoded with computer-readable program code, which when executed by a computer, causes the computer to implement a method. The method includes registering a client for impaired driving prevention services. The impaired driving prevention services provide access to driver services for the client when the client is impaired. The method also includes incorporating a benefit into an insurance policy of the client with respect to the impaired driving prevention services. The method further includes processing impaired driving prevention activities conducted between a driver service and the client, storing the results of the processed activities in a database record of the client, and reporting the results of the processed activities to an insurance provider that issued the insurance policy. A future benefit for the client is determined as a function of the results.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A depicts a simplified system upon which the impaired driving prevention services may be implemented in accordance with an embodiment of the present invention;

FIG. 1B depicts a detailed version of the system of FIG. 1A in accordance with an embodiment of the present invention;

FIG. 2 depicts a flow diagram of a process for implementing the impaired driving prevention services according to an embodiment of the present invention;

FIG. 3 depicts a flow diagram of a process for implementing registration features associated with the impaired driving prevention services according to an embodiment of the present invention;

FIG. 4 depicts a plurality of database records created for implementing the impaired driving prevention services according to an embodiment of the present invention;

FIG. 5 depicts a flow diagram of a process for implementing qualification features associated with the impaired driving prevention services according to an embodiment of the present invention;

FIG. 6 depicts a flow diagram of a process for implementing certification features associated with the impaired driving prevention services according to an embodiment of the present invention;

FIG. 7 depicts a flow diagram of a process for tracking activities associated with the impaired driving prevention services according to an embodiment of the present invention; and

FIG. 8 depicts a user interface for implementing the impaired driving prevention services according to an embodiment of the present invention.

### DETAILED DESCRIPTION

Exemplary embodiments provide an automated system that provides insurance benefits to individuals and entities that utilize qualified driving services when an impairment condition is encountered. For example, an entity, such as a bar or restaurant may utilize qualified driving services for their patrons in an effort to prevent or reduce impaired driving due to excess alcohol consumption. The entity is provided with an insurance benefit for complying with certain prescribed requirements. In another example, an individual may be provided with a benefit, such as an insurance discount or discounted price for agreeing to use a qualified driving service when impaired.

The impaired driving prevention (IDP) system qualifies alcohol serving establishments for the service, tracks activities conducted among impaired driving prevention service users, which includes certification of establishment staff in recognizing and acting on impaired customer situations, engaging a driver service for impaired customers, providing an insurance benefit to the establishment for use of the service, and reporting on the results of implementation of the service over time. These, and other, features of the impaired driving prevention system and network will now be described.

It is understood in advance that although this disclosure includes a description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

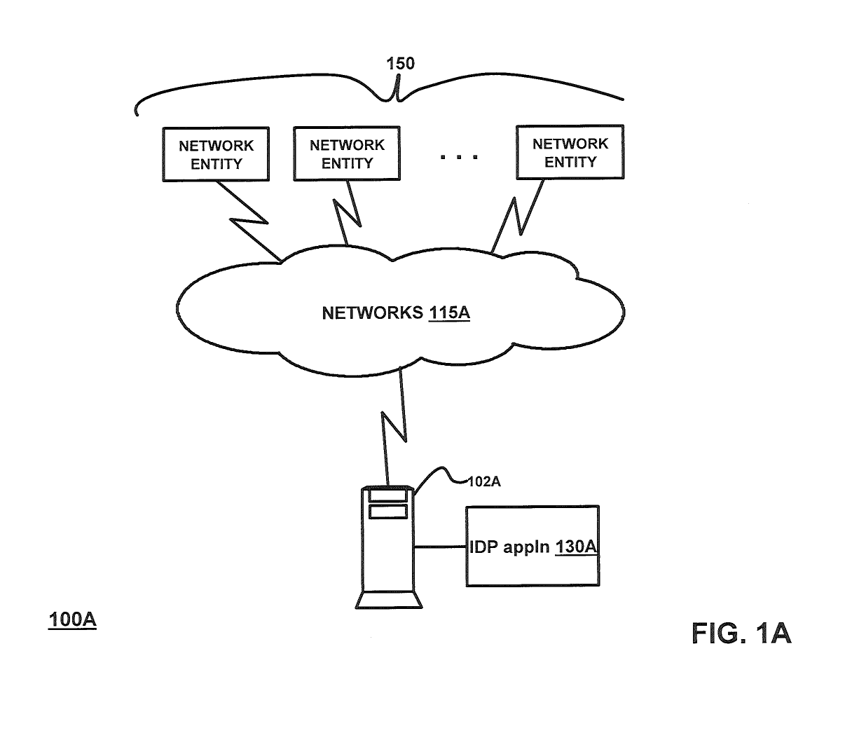

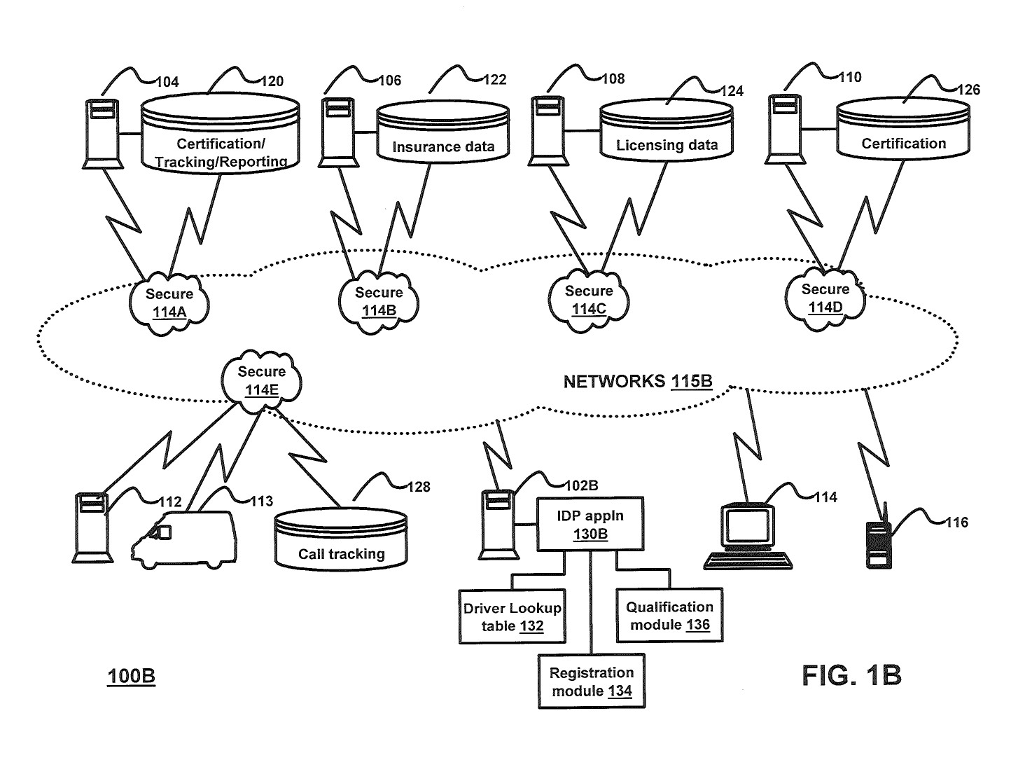

Turning now to FIGS. 1A and 1B, a system 100A-100B (collectively referred to as system 100) upon which the impaired driving prevention network may be implemented will now be described in an exemplary embodiment. The system 100 may be implemented via a cloud computing architecture. Alternatively, the system 100 may be implemented, e.g., using a client/server architecture.

In FIG. 1A, the system 100A includes a host system computer 102A communicatively coupled to one or more networks 115A. The host system computer 102A represents an entity that provides, at least in part, the impaired driving prevention services. The system 100A also includes various network entities 150 that are also communicatively coupled to the networks 115A. In one embodiment, the host system 102A may be a third-party enterprise that hosts the IDP services, and executes an application 130A for providing these services on behalf of end users (e.g., network entities 150). Alternatively, one or more of the network entities 150 may implement the IDP services. In this embodiment, one or more of the network entities 150 may execute the application 130A or a portion thereof. These network entities 150 are described further in FIG. 1B.

Also shown in FIG. 1B, are host system computer 102B, as well as computer systems 104, 106, 108, 110, and 112, each of which is communicatively coupled to networks 115B. The host system 102A and 102B is collectively referred to as 102, and the network 115A and 115B is collectively referred to as 115. The computer system 104 is operable by individuals associated with an alcohol serving establishment, e.g., a restaurant, bar, hotel, or other venue. The computer system 106 is operable by one or more individuals associated with an insurance provider (e.g., insurance company). The computer system 108 is operable by one or more individuals of a government agency (e.g., liquor license bureau or law enforcement entity). The computer system 110 is operable by one or more individuals associated with a certification entity. The computer system 112 is operable by one or more individuals associated with a driving service or driver-for-hire service (e.g., Amride™, LLC).

Also shown in FIG. 1B are end user computer systems 114 and 116. Computer system 114 may be a general-purpose computer, such as a desktop, and computer system 116 may be a portable device, such as a smart phone or tablet PC.

The computer systems 104, 106, 108, 110, 112, 114 and 116 of FIG. 1B represent the network entities 150 shown in FIG. 1A.

The host system computer 102B (which corresponds to the host system 102A), as well as the computer systems 104, 106, 108, 110, and 112 may each be implemented as a high-speed computer processing device for handling the volume of activities associated with users of the impaired driving prevention services network. The exemplary impaired driving prevention services may be implemented through the host system computer 102B, as a service provider enterprise, or application service provider (ASP) entity. As shown in FIG. 1B, portions of the impaired driving prevention services may be implemented by one or more other network entities (e.g., in a distributed computing network). For example, it will be understood that the impaired driving prevention services may be implemented by the driver service (computer system 112), the certification entity (computer system 110), the government agency (computer system 108), the insurance provider (computer system 106), and/or the alcohol serving establishment (computer system 104).

In an alternative embodiment, one or more of the host system computer 102, and computer systems 104, 106, 108, 110, and 112, as well as end user computer systems 114 and 116 may be implemented as general-purpose computers (e.g., desktops or laptops), mobile devices, such as a smart phone, tablet, or personal digital assistant. As shown in FIG. 1B, e.g., end user computer system 114 may be a general-purpose computer and end user computer system 116 may be a smart phone.

A vehicle 113 may also be communicatively coupled to the networks 115B and executes driver service operations, as will be described herein. The vehicle 113 may be equipped with mobile communications devices and technology, e.g., cellular or satellite communication technology and devices. While only a single instance of each entity associated with computer systems 102, 104, 106, 108, 110, 112, 113, 114, and 116 is shown in FIG. 1 for ease of illustration, it will be understood that the impaired driving prevention services can be readily extended to many of such systems and entities over the networks 115B in order to realize the advantages of the invention.

The system 100B of FIG. 1B also includes storage devices for implementing the exemplary impaired driving prevention services.

As shown in FIG. 1B by way of non-limiting example, storage devices may be distributed across the networks 115B and may be accessible through corresponding secure networks. For example, registration, qualification, certification, tracking, and reporting activities may be conducted via an application executable by the host system computer 102B. The host system computer 102B may access a storage device 120 (through a secure network 114A) associated with the alcohol serving establishment to retrieve certification information on staff members of the establishment associated with computer system 104. Likewise, the host system computer 102B may access a storage device 122 (through a secure network 114B) to retrieve insurance information on IDP policy holders. Further, liquor license information may be retrieved from a storage device 124 (via a secure network 114C) by the host system computer 102B. Additionally, the host system computer 102B may access a storage device 126 associated with the certification entity of computer system 110 (through a secure network 114D) to obtain certification information on staff members of the alcohol serving establishment associated with the computer system 104. Alternatively, where the alcohol serving establishment performs their own certifications, the information stored in the storage device 126 may be stored in a database managed by the certification entity (not shown). Finally, the host system computer 102B may access a storage device 128 (through a secure network 114E) associated with the driver service operating the computer system 112.

In an alternative embodiment, rather than accessing the storage devices by the host system computer 102B through secure networks, one or more of the computer systems 104, 106, 108, 110, and 112 may access data from their corresponding storage devices, and transmit this data as needed, to the host system computer 102B. In yet a further alternative embodiment, if the host system 102A of FIG. 1A implements the IDP services, the storage devices may be implemented directly by the host system 102A.

Each of the secure networks 114A-114E may provide limited information to the host system computer 102B through defined access permissions determined by authorized representatives associated with the corresponding computer systems 104, 106, 108, 110, and 112, respectively. In an embodiment, the host system computer 102B may access, for example, a public network 115B (e.g., Internet) and continue on through a secure network to another network entity based on access protocols.

It will be understood by one of ordinary skill in the art that other network configurations may be utilized for realizing the advantages of the present invention. The configuration shown in FIG. 1B is for illustrative purposes and is not to be construed as limiting in scope.

As shown in FIG. 1B, the host system 102B implements an IDP application 130B for performing the exemplary impaired driving prevention services described herein. The application 130B corresponds to the application 130A and is collectively referred to herein as application 130. In an embodiment, the application 130B may include various modules and may have access to one or more databases stored in the host system computer 102B to store and retrieve data as needed. For example, as shown in FIG. 1B, the application 130B may access a driver service look up table 132 that stores one or more records of driver service entities (e.g., computer system 112) that provide driving services or driver-for-hire services. The application 130B also includes logic (modules 134 and 136, respectively) for registering and qualifying applicants for receiving the IDP services, as will be described further herein.

As indicated above, the storage devices 120, 122, 124, 126, and 128 are accessible through networks 115B via respective secure networks 114A, 114B, 114C, 114D, and 114E. The storage devices may be implemented using a variety of devices for storing electronic information. It is understood that one or more of the storage devices may be implemented using memory contained in the host system computer 102B or may be separate physical devices, as illustrated in FIG. 1B. The storage devices may be logically addressable as a consolidated data source across a distributed environment that includes the networks 115B. Information stored in the storage devices may be retrieved and manipulated via the host system computer 102B and authorized users of computer systems 104, 106, 108, 110, 112, and 113.

The networks 115 may be any type of known networks including, but not limited to, a wide area network (WAN), a local area network (LAN), a global network (e.g. Internet), and an intranet. The networks 115 may include a private network in which access thereto is restricted to authorized members. As shown in FIG. 1B, secure networks 114A-114E are private networks. The networks 114A-114E and 115 may be implemented using wireless networking technologies or any kind of physical network implementation known in the art. Computer systems 104, 106, 108, 110, 112, 113, 114, and 116 may be coupled to the host system computer 102B through multiple networks (e.g., Internet, intranet, and private network) so that not all computer systems are coupled to the host system computer 102B through the same networks.

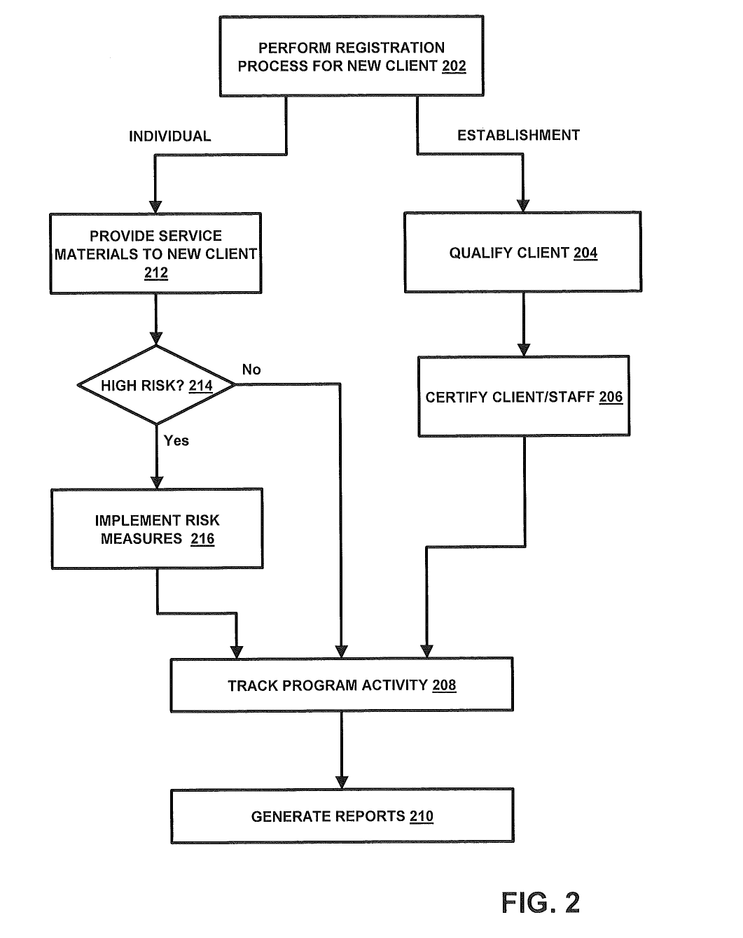

Turning now to FIG. 2, a flow diagram describing a process for implementing the impaired driving prevention services will now be described in an embodiment. As indicated above, the IDP services may be implemented for an individual and/or may be provided to business establishments that serve alcohol. The process described in FIG. 2 assumes that a client is requesting registration for the impaired driving prevention services. Steps 202, 212, 214, 216, 208, and 210 reflect the process implemented wherein the client is an individual requesting personal IDP services, and steps 202-210 reflect the process implemented for an establishment (e.g., a commercial enterprise or entity).

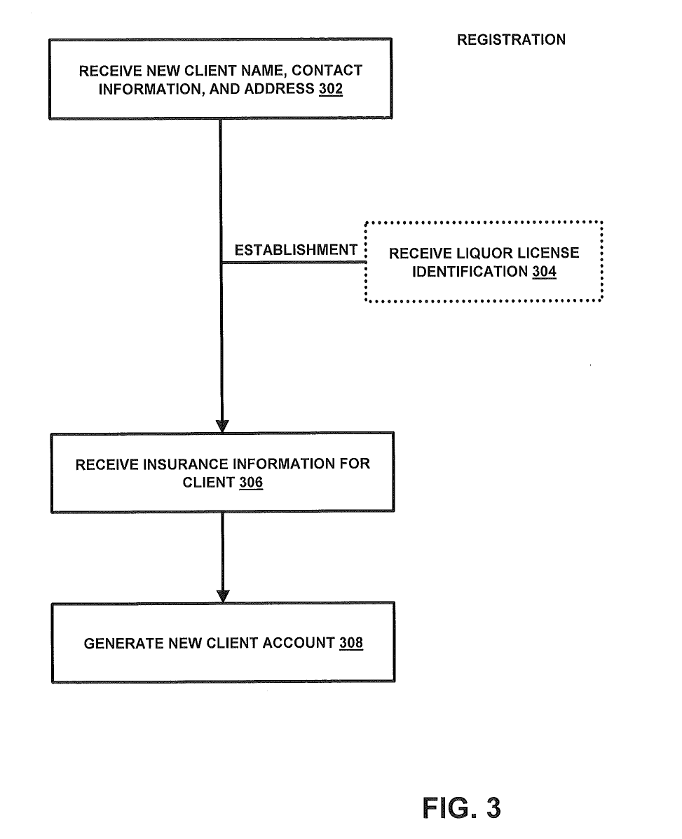

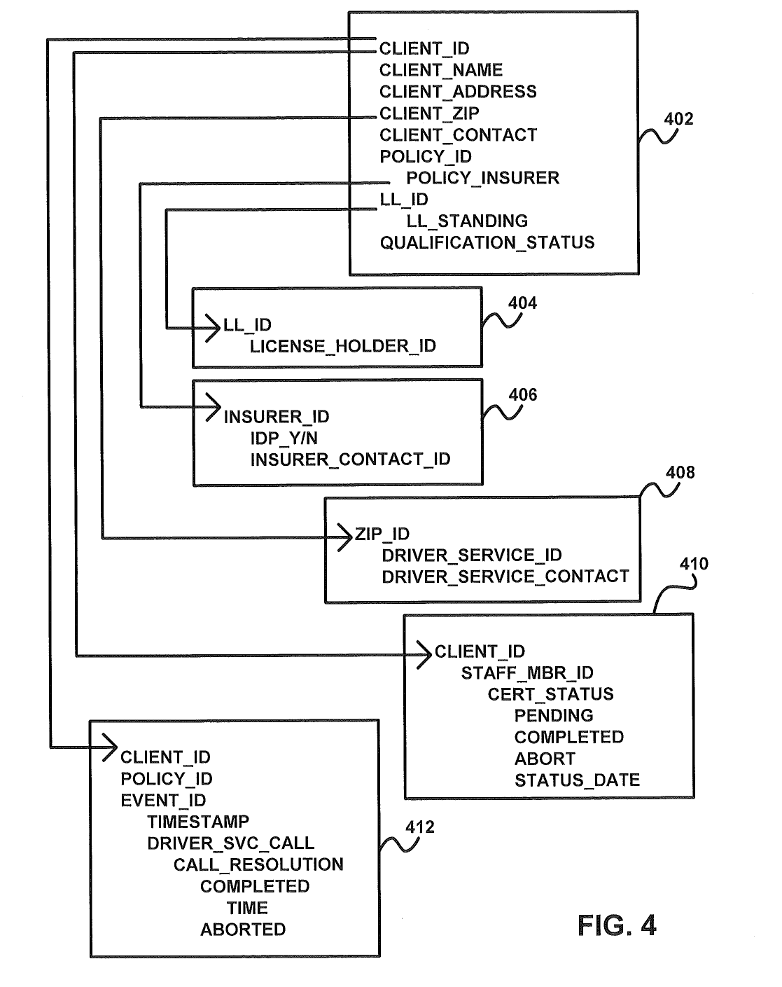

At step 202, the host system computer 102 provides a web interface accessible to individual (e.g., via one of the computer systems 114 and 116) or to the establishment (e.g., computer system 104). If the registrant is the establishment, a user of the computer system 104 (also referred to as client) accesses the web interface to register. The registration process may be implemented by the application 130 through the registration module 134. The host system computer 102 collects information about the client, such as identification information. A detailed embodiment of this registration process is described further in FIG. 3. The client information that is collected, as well as other information (described further herein), is stored in databases, samples of which are shown and described in FIG. 4

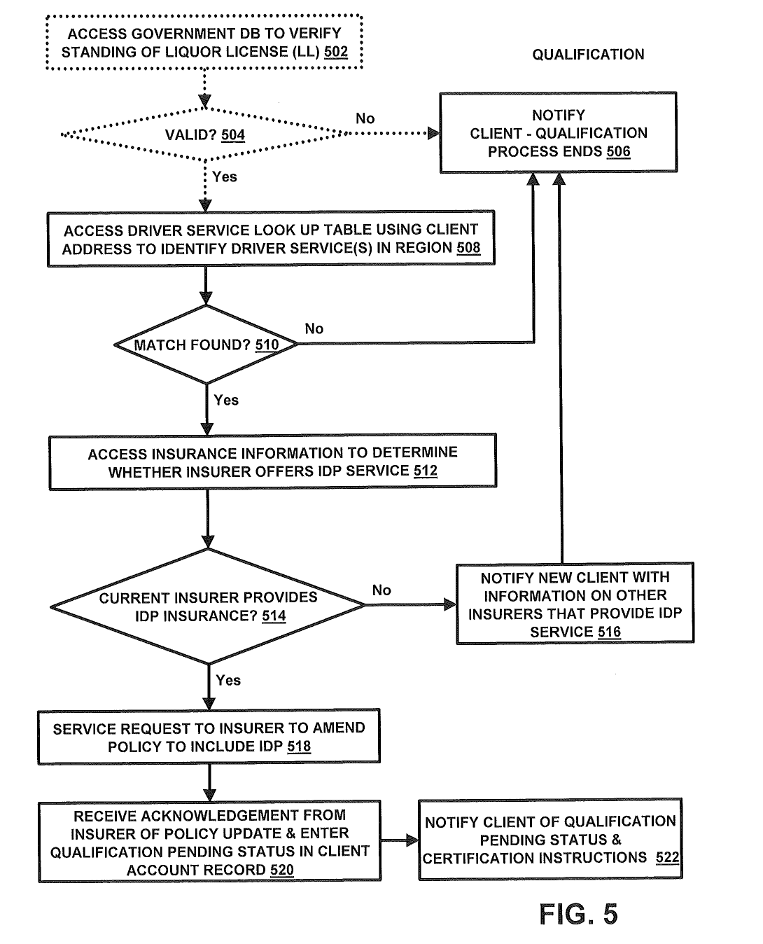

At step 204, the qualification module 136 uses information provided in the registration process to qualify the client for the impaired driving prevention services. The qualification process includes determining whether a driver service is available for the location of the client and also that an insurer is capable of providing associated benefits of the impaired driving prevention service through, e.g., an insurance policy between the insurer and the client. This qualification process is further described in FIG. 5.

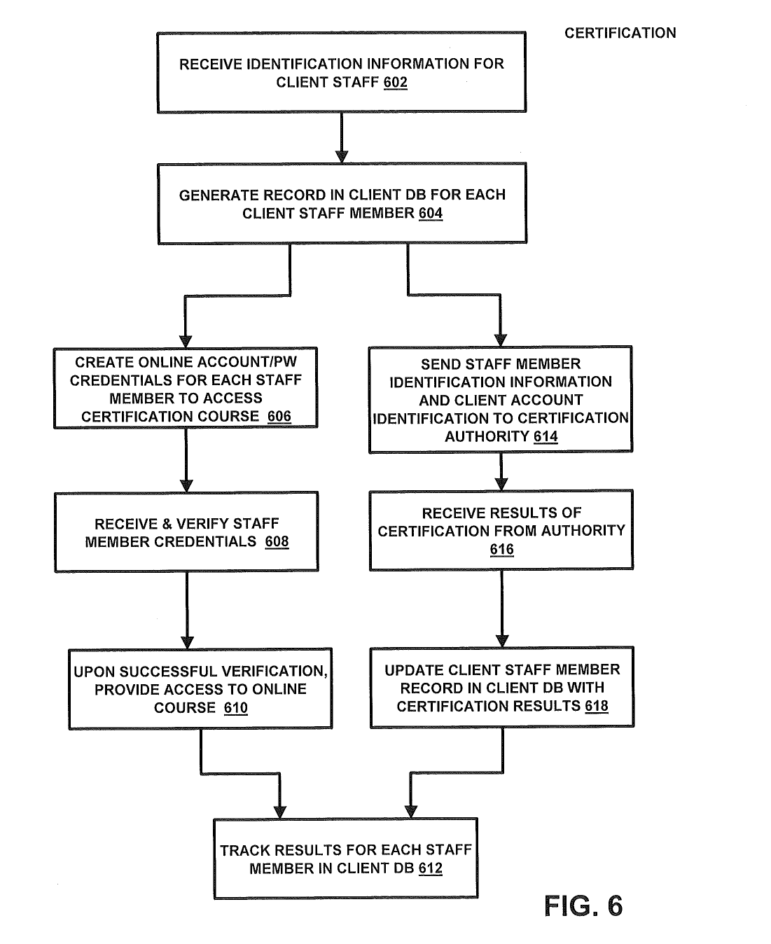

Once qualified, the host system computer 102 provides instructions to the client concerning certification of its staff members. The certification process may be performed through the impaired driving prevention service provider (e.g., the host system computer 102) or may be farmed out to a qualified certification entity (e.g., certification entity associated with computer system 110). If performed by a third party entity, the host system computer 102 is configured to communicate and receive certification results of the certification process. An embodiment of a certification process is described further in FIG. 6.

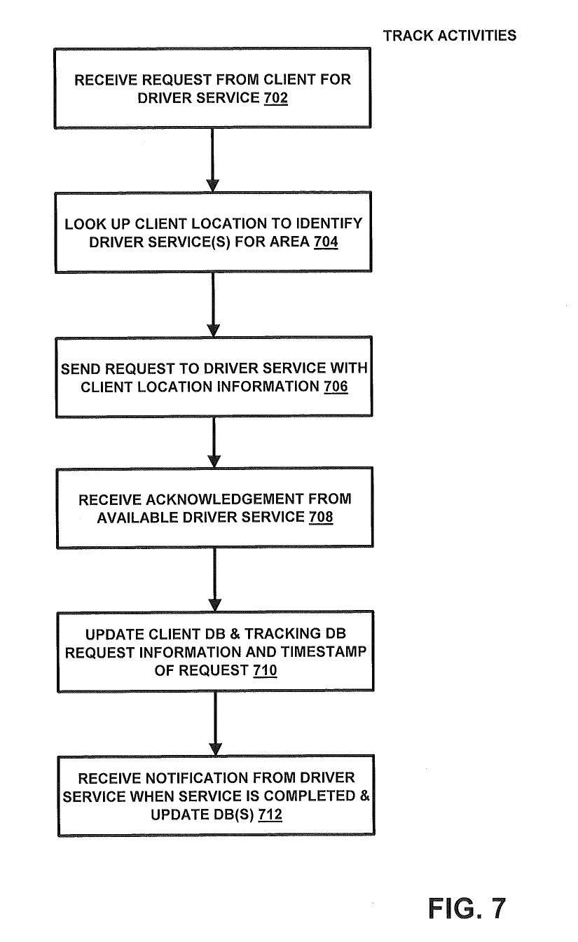

Once the certification process has been successfully performed, the application 130 tracks activities conducted between the driver service and the establishment at step 208. In an embodiment, the activities may be tracked by the driver service (e.g., captured as call tracking information in the storage device 128, which is accessed by the host system computer 102 via the networks 114E and 115). This process is described further in FIG. 7.

At step 210, the host system computer 102 generates reports of these activities and sends the reports to the respective insurance companies along with client or policy information. The insurance companies may use this information to execute the benefit (e.g., an insurance discount), modify the policy (e.g., to increase, decrease, or eliminate the benefit), and to resolve any issues that may have occurred in the execution of the driver service activities.

As indicated above, the IDP services of FIG. 2 can also be applied for an individual (e.g., a user of one of computer systems 114 and 116). In this embodiment, once the registration process is complete at step 202, the application 130 provides materials about the IDP services to the individual at step 212. The materials provide the individual with information describing how the IDP services work and also instructions for compliance with the services. For example, requirements may include seeking a driving service by the individual when the individual is impaired and might otherwise risk public or personal safety if an attempt to drive his/her vehicle is made. The materials may also include information concerning insurance benefits provided for agreeing to use the services. In this regard, in one embodiment, the materials may include an addendum to an insurance policy providing this benefit. This addendum may be provided, e.g., by the computer system 106 and host system computer 102B via the networks 115B, or directly by the computer system 106 to the individual (e.g., computer system 114 or 116).

In an embodiment, the IDP services may be configured to provide more detailed services for individuals based on, e.g., insurance risks attributable to the individuals. For example, an individual who is facing suspension of his/her driver's license based on past impaired driving incidents may be provided with an opportunity (e.g., through the legal system) to register for the IDP services in lieu of the license suspension or other penalty. This type of individual is referred to as high risk. Alternatively, the individual may not be facing legal penalties, but may be having difficulty obtaining vehicle insurance due to past impaired driving incidents. An insurer may provide the opportunity for the individual to register for the IDP services as a condition of providing an insurance policy. In either situation above, benefits for the individual include one or more of avoiding fines or penalties, reduced fines or penalties, avoidance or delay of license suspension, and the ability to obtain insurance. Benefits for the insurer may include reduced claims due to a lower frequency of accidents and injury, as well as public and community appreciation and good will.

Turning back to FIG. 2, the IDP services include determining whether the individual is high risk at step 214, which may be established by court or legal records, or refusal by insurers to insure the individual. If the individual is not high risk at step 216, the process proceeds to step 208, whereby the IDP services track activities, such as the date and frequency in which the individual has used a driving service, and/or a time period in which no incidences of impaired driving have been reported for the individual. This information may be tracked, in part, by records of calls completed by a corresponding driver service (e.g., computer system 112) and call tracking data stored in storage device 128, whereby the call record information is transmitted to the host system computer 102 and/or insurance provider (computer system 106).

Otherwise, if the individual is determined to be high risk at step 214, the IDP services determine and implement additional risk measures at step 216. The additional risk measures may be proscribed by the insurer and/or government agencies, such as the court system and, if applicable, they may be configured to conform to state, federal, and/or local laws. In one embodiment, the additional risk measures may include installing a device (not shown) in the individual's vehicle (not shown) for monitoring driving behavior. For example, in one embodiment, assuming a vehicle is equipped with sensors that determine when the vehicle veers outside of a lane, a device that is coupled to the vehicle's control system may be able to gather this information in conjunction with other available information such as rate of acceleration, speed, and other factors that may point to a possible impairment condition. Thus, if the vehicle veers out of its lane for a threshold period of time and/or at a threshold frequency within a period of time, it may be determined that the driver is impaired. Other devices may alternatively employed (or employed in conjunction therewith), such as a device that measures the individual's blood alcohol content (e.g., by breathing into the device). Once the risk measures are implemented, the process proceeds to step 208, whereby the IDP services track activities, such as the data received from the risk prevent measures, and associated reports may be generated at step 210.

Turning now to FIG. 3, the registration process from step 202 of FIG. 2 will now be described in further detail. At step 302, the application 130 prompts the client for information, such as client name, address, zip code, and contact information. If the client is an alcohol serving establishment, the registration process may include prompting the client for liquor license information (e.g., license ID, nature of license (e.g., full or partial, date of license, and/or expiration date) at step 304.

At step 306, the registration module 134 prompts the client for current insurance information, such as insurer name, address, policy number, etc. At step 308, the registration module 134 generates a client account for the client. A sample client record 402 for an alcohol serving establishment is shown in FIG. 4. A client record for an individual may be similar to the client record 402 will not include some of the fields shown therein. As indicated above, if the client is an individual, the host system service provides IDP materials to the client with information about the program, and the IDP process continues to FIG. 7. Otherwise, if the client is an alcohol serving establishment, the IDP process continues to FIG. 5.

Turning now to FIG. 5, a qualification process for a prospective client who is an alcohol serving establishment will now be described. Optionally, at step 502, the qualification module 136 accesses a government database (e.g., storage device 124 associated with computer system 108) to determine a current status of a liquor license of the client. A sample database record 404 associated with the government entity of computer system 108 is shown in FIG. 4. For example, liquor license information for the client may be obtained from the storage device 124 and entered in the client record 402 (e.g., LL_ID) and the record 404 (e.g., as LL_ID (liquor license identifier) and LICENSE_HOLDER_ID (identification of the entity to which the license has been issued)). As shown in record 402, the liquor license information includes the standing (LL_STANDING), which refers to the status of the license (e.g., valid, expired, revoked, etc.).

At step 504, optionally, the qualification module 136 determines the current status or standing (e.g., valid, expired, revoked, etc.) from the information acquired in step 502. As indicated above, this information may be stored in records 402 and 404 of FIG. 4. Alternatively, if steps 502 and 504 are not performed, the license information can be obtained through other avenues.

At step 506, if the license is not valid, the qualification module 136 notifies the client that they are not eligible for the IDP services, and the process ends. However, if the license is valid at step 506, the application 130 accesses the driver service look up table 132, which stores a listing of driver services and related information, such as name, address, zip code, contact number/address, pricing tables, etc. The driver service look up table may be configured for searching by service provider name, zip code, price, or other parameter. As shown in FIG. 4, for example, a database record 408 illustrates sample indexing data by which the driver services can be searched, such as by zip code (ZIP_ID).

The application 130 may use the zip code of the client to search the driver service look up table for driver services that provide service to the region associated with the zip code of the client. If no match is found at step 510, the process returns to step 506 and the client is notified that no service exists for that area. Otherwise, if a match is found, the application 130 accesses insurance information associated with the client to determine if the client's current insurance provider offers the IDP service discount or benefit at step 512. Alternatively, if the client is currently uninsured, the application 130 may search insurance databases (e.g., storage device 122) for the insurer provider computer system 106 and other insurance systems to identify an insurer that provides this service.

If the client's current insurer does not provide the IDP services at step 514, the application 130 notifies the client and provides information on other insurers who do provide this service at step 516. Otherwise, if the client's insurance company does provide the IDP services, the application 130 sends a service request to the insurer (e.g., a request through the networks 115 and 114B to the computer system 106) at step 518.

Once the insurer has received and approved the request, it sends an acknowledgement of the approval to the host system computer 102, and the qualification module 136 updates a status in the client record 402 of FIG. 4 at step 520 (e.g., through fields POLICY_ID and POLICY_INSURER). The qualification module 136 notifies the client of the approval and sends instructions for certifying staff members for the service at step 522.

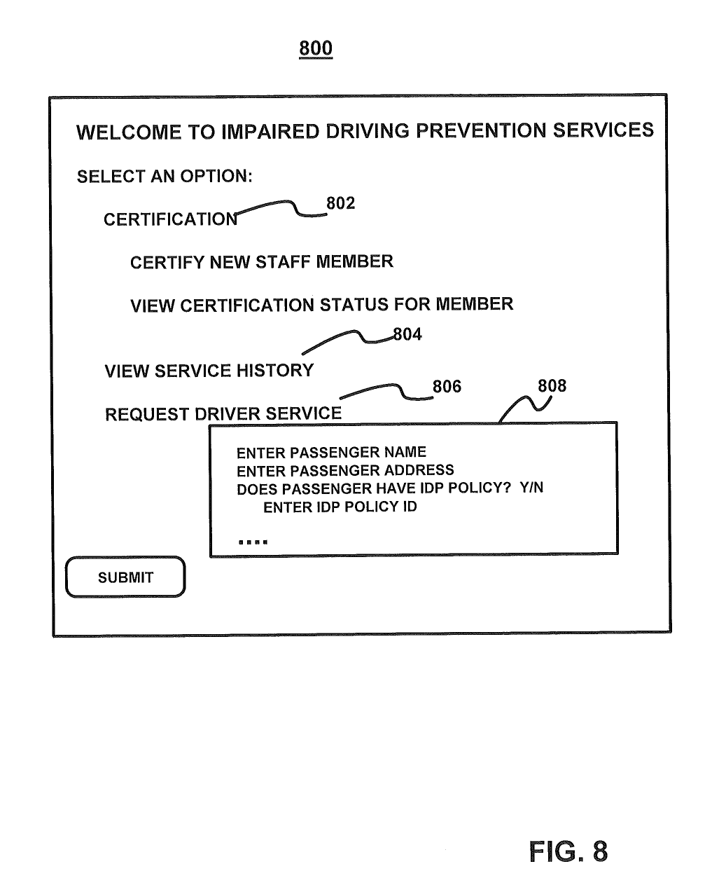

Turning now to FIG. 6, a certification process for the IDP services will now be described in an embodiment. The certification process may be performed inhouse by the alcohol serving establishment (e.g., computer system 104), remotely by a third-party certification establishment (e.g., computer system 110), or a combination thereof. FIG. 8 illustrates a user interface screen 800 for a website of the IDP services in which certification processes may be performed at least in part through the application 130 and host system computer 102. As shown in FIG. 8, a user may select an option 802 to initiate this process (or alternatively, to review pending or current certification statuses).

The application 130 (e.g., through its website) receives identification information for each client staff member, such as any server of alcohol at step 602. At step 604, the application 130 generates a client record for each staff member, a sample of which is shown in FIG. 4 (record 410). As shown in FIG. 4, the record 410 may include fields to identify the client (e.g., bar or establishment) by CLIENT_ID, the client's employees (e.g., bartenders, wait staff) by STAFF_MBR_ID, and a certification status (e.g., pending certification, or PENDING; course completion, or COMPLETED; course incomplete or aborted, ABORT; and a date of the above-referenced statuses, STATUS_DATE).

Steps 606-612 relate to inhouse certification processes, and steps 614-618 and 612 relate to remote third-party certification processes. In either process, the application 130 maintains particular data regarding the certification process.

In step 606, the application 130 creates an online account and password credentials for each staff member to access a certification course. At step 608, the certification course logic receives and verifies the user's credentials. Upon successful verification, the course logic provides access to the course information at step 610. At step 612, the application 130 tracks results from activities conducted through the course for each member and updates the staff member record 410.

Turning back to step 604, if the certification course is conducted remotely by a third-party provider, the application 130 sends staff member identification information and client account identification to the certification authority at step 614. At step 616, the application 130 receives results of the certification from the authority (e.g., pass, incomplete, etc.). At step 618, the application 130 updates the staff member record 410 with the certification results.

Once the registration, qualification, and certification processes are complete, or alternatively in the case of an individual, once the registration process is complete, the IDP services are configured to track IDP related activities, as will now be described in FIG. 7. The process of FIG. 7 assumes that an impairment condition has been determined either by a staff member of an alcohol serving establishment or is self-determined by an individual.

At step 702, the application 130 receives a request from the client for a driver service. The application 130 determines the location of the client and identifies one or more driver services that service that location (e.g., through the driver service look up table 132) at step 704.

At step 706, the application 130 transmits a request for a driver to the driver service(s) with location information of the client. This may be performed through the networks 115 and network 114E.

At step 708, an acknowledgement is received from at least one of the driver services indicating availability. If more than one driver service is available, the application 130 may automatically select from the available driver services based on parameters, such as proximity of service to client, client preferences, prices, etc.

At step 710, the application 130 generates a record of the call (a sample of which is shown in record 412 of FIG. 4) and updates record 412 with the details of the call. At step 712, the application 130 receives notification from the driver service (e.g., either through the computer system 112 or vehicle 113), and the application 130 updates the record 412 accordingly. As shown in record 412, information fields used in tracking IDP services include a client identification (CLIENT_ID), an insurance policy identifier (POLICY_ID), and a service call, e.g., initiated when a driver service is contacted to pick up an individual (EVENT_ID). The service call information may further include a date and time of the call (TIMESTAMP), an indicator of the driver service called, e.g., a unique identifier of the call (DRIVER_SVC_CALL), as well as a call resolution that indicates whether the driver service has completed a passenger pick up for the event (CALL_RESOLUTION, COMPLETED, TIME completed, and ABORTED).

As shown in FIG. 8, e.g., the user interface screen 800 may be used to initiate the call by the alcohol serving establishment through options 806 and window 808. Other functions available through the user interface screen 800 may include viewing call or service histories by selecting option 804.

It will be understood that the user interface screen 800 is one of many different ways the IDP services may be implemented and is shown and described herein by way of non-limiting example. For example, at least a portion of the options shown in FIG. 8 (e.g., 804, 806, and 808) may be implemented by a client of the IDP services, e.g., through a client-side mobile application executable on the device 116 (FIG. 1) or through a client-side application executable by the device 114 (FIG. 1). Alternatively, an end user of the IPD services may call a direct line, e.g., by phone, to contact a host provider of the IDP services. All that is required is that the IPD service host provider has access to the identity of the end user and the user's location.

Turning back to FIG. 4, the IDP services may be configured to generate records/databases for tracking the processes from registration to reporting. As shown in FIG. 4, the various databases may include at least one field that can be used as a pointer to retrieve information from other records/databases. For example, as shown in FIG. 4, the field CLIENT_ID may be used as a pointer to records 410 and 412. Through this record generation and tracking processes, the application 130 may be configured to generate various reports of call/service histories and certification information usable by an insurer to determine adjustments to benefits provided. For example, an establishment/client that has a predetermined frequency of IDP service use (defined by the insurer based on statistical data) proportionate to its average customer volume may receive a greater benefit (e.g., larger insurance discount) than an establishment whose frequency of IDP service is disproportionately lower based on its average customer volume.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, HTML, JavaScript, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method, comprising:
registering a client for impaired driving prevention services via a computer processor, the impaired driving prevention services providing access to driver services for the client when the client is impaired, wherein agreement by the client to use the driver services when an impairment situation occurs is a condition of registration;
incorporating a benefit into an insurance policy of the registered client with respect to the impaired driving prevention services;
processing, via the computer, impaired driving prevention activities conducted between one or more of the driver services and the client;
storing results of processed activities in a database record of the client; and
reporting the results of the processed activities to an insurance provider that issued the insurance policy, wherein a future benefit for the client is determined as a function of the results.

2. The method of claim 1, wherein the client is an establishment that serves alcohol to patrons, the method further comprising qualifying the client to receive the impaired driving prevention services, the qualifying comprising:
verifying a validity of a liquor license held by the establishment;
verifying, from a driver service look up table, that at least one of the driver services provides service to a region in which the establishment is physically located;
verifying whether an insurance provider of the establishment is registered with the impaired driving prevention services to provide the benefit;
if the insurance provider is registered, determining the establishment is qualified for the impaired driving prevent services and sending a service request to the insurance provider indicating qualification; and
if the insurance provider is not registered:
notifying the establishment that the insurance provider is not registered;
searching a database of registered insurance providers; and
transmitting information regarding at least one insurance provider in the database of registered insurance providers that is registered.

3. The method of claim 1, wherein the client is an individual that patronizes an alcohol-serving establishment, the method further comprising qualifying the individual to receive the impaired driving prevention services, the qualifying comprising:
determining a risk level of the individual that corresponds to previous incidences of impaired driving; and
implementing risk reduction measures based on the risk level, the risk reduction measures including at least one of:
waiving an enforceable penalty assessed against the individual as a condition of agreement by the individual to use the impaired driving prevention services according to its terms; and
providing vehicle insurance to the individual as a condition of agreement by the individual to use the impaired driving prevention services according to its terms.

4. The method of claim 1, further comprising:
tracking activities conducted by the client with respect to usage of the impaired driving prevention services, the tracking including:
logging dates of use of a driver service, the dates of use received from the driver service;
determining time periods in which no incidences of impaired driving have been reported.

5. The method of claim 4, wherein the usage of the impaired driving prevention services includes an instance in which the client, having access to a vehicle, is transported between two designated locations by the driver service in lieu of the client operating the vehicle.

6. The method of claim 1, wherein the client is an establishment that serves alcohol to patrons, the method further comprising certifying employees of the establishment, through coursework, to recognize alcohol-related impairment conditions and determine a corresponding action.

7. The method of claim 1, wherein the client is an establishment that serves alcohol to patrons, the method further comprising providing, via a user interface, an option for tracking certification of employees of the establishment, and an option for requesting a driver service for a patron who is impaired.

8. A system, comprising:
a memory having computer readable computer instructions; and
a processor for executing the computer readable instructions, the computer readable instructions including:
registering a client for impaired driving prevention services via a computer processor, the impaired driving prevention services providing access to driver services for the client when the client is impaired, wherein agreement by the client to use the driver services when an impairment situation occurs is a condition of registration;
incorporating a benefit into an insurance policy of the registered client with respect to the impaired driving prevention services;
processing, via the computer, impaired driving prevention activities conducted between one or more of the driver services and the client;
storing results of processed activities in a database record of the client; and
reporting the results of the processed activities to an insurance provider that issued the insurance policy, wherein a future benefit for the client is determined as a function of the results.

9. The system of claim 8, wherein the client is an establishment that serves alcohol to patrons, the computer readable instructions further including qualifying the client to receive the impaired driving prevention services, the qualifying comprising:
verifying a validity of a liquor license held by the establishment;
verifying, from a driver service look up table, that at least one of the driver services provides service to a region in which the establishment is physically located;
verifying whether an insurance provider of the establishment is registered with the impaired driving prevention services to provide the benefit;
if the insurance provider is registered, determining the establishment is qualified for the impaired driving prevent services and sending a service request to the insurance provider indicating qualification; and
if the insurance provider is not registered:
notifying the establishment that the insurance provider is not registered;
searching a database of registered insurance providers; and
transmitting information regarding at least one insurance provider in the database of registered insurance providers that is registered.

10. The system of claim 8, wherein the client is an individual that patronizes an alcohol-serving establishment, the computer readable instructions further including qualifying the individual to receive the impaired driving prevention services, the qualifying comprising:
determining a risk level of the individual that corresponds to previous incidences of impaired driving; and
implementing risk reduction measures based on the risk level, the risk reduction measures including at least one of:
waiving an enforceable penalty assessed against the individual as a condition of agreement by the individual to use the impaired driving prevention services according to its terms; and
providing vehicle insurance to the individual as a condition of agreement by the individual to use the impaired driving prevention services according to its terms.

11. The system of claim 8, wherein the computer readable instructions further include:
tracking activities conducted by the client with respect to usage of the impaired driving prevention services, the tracking including:
logging dates of use of a driver service, the dates of use received from the driver service;
determining time periods in which no incidences of impaired driving have been reported.

12. The system of claim 11, wherein the usage of the impaired driving prevention services includes an instance in which the client, having access to a vehicle, is transported between two designated locations by the driver service in lieu of the client operating the vehicle.

13. The system of claim 8, wherein the client is an establishment that serves alcohol to patrons, the computer readable instructions further including certifying employees of the establishment, through coursework, to recognize alcohol-related impairment conditions and determine a corresponding action.

14. A computer program product comprising a computer-readable medium having program instructions embodied thereon, which when executed by a computer processor, causes the computer processor to implement:
registering a client for impaired driving prevention services via a computer processor, the impaired driving prevention services providing access to driver services for the client when the client is impaired, wherein agreement by the client to use the driver services when an impairment situation occurs is a condition of registration;
incorporating a benefit into an insurance policy of the registered client with respect to the impaired driving prevention services;
processing, via the computer, impaired driving prevention activities conducted between one or more of the driver services and the client;
storing results of processed activities in a database record of the client; and
reporting the results of the processed activities to an insurance provider that issued the insurance policy, wherein a future benefit for the client is determined as a function of the results.

15. The computer program product of claim 14, wherein the client is an establishment that serves alcohol to patrons, the program instructions further comprising qualifying the client to receive the impaired driving prevention services, the qualifying comprising:
verifying a validity of a liquor license held by the establishment;
verifying, from a driver service look up table, that at least one of the driver services provides service to a region in which the establishment is physically located;
verifying whether an insurance provider of the establishment is registered with the impaired driving prevention services to provide the benefit;
if the insurance provider is registered, determining the establishment is qualified for the impaired driving prevent services and sending a service request to the insurance provider indicating qualification; and
if the insurance provider is not registered:
notifying the establishment that the insurance provider is not registered;
searching a database of registered insurance providers; and
transmitting information regarding at least one insurance provider in the database of registered insurance providers that is registered.

16. The computer program product of claim 14, wherein the client is an individual that patronizes an alcohol-serving establishment, the program instructions further comprising qualifying the individual to receive the impaired driving prevention services, the qualifying comprising:
determining a risk level of the individual that corresponds to previous incidences of impaired driving; and
implementing risk reduction measures based on the risk level, the risk reduction measures including at least one of:
waiving an enforceable penalty assessed against the individual as a condition of agreement by the individual to use the impaired driving prevention services according to its terms; and
providing vehicle insurance to the individual as a condition of agreement by the individual to use the impaired driving prevention services according to its terms.

17. The computer program product of claim 14, wherein the program instructions further comprise:
tracking activities conducted by the client with respect to usage of the impaired driving prevention services, the tracking including:
logging dates of use of a driver service, the dates of use received from the driver service;
determining time periods in which no incidences of impaired driving have been reported.

18. The computer program product of claim 17, wherein the usage of the impaired driving prevention services includes an instance in which the client, having access to a vehicle, is transported between two designated locations by the driver service in lieu of the client operating the vehicle.

19. The computer program product of claim 14, wherein the client is an establishment that serves alcohol to patrons, the program instructions further comprising certifying employees of the establishment, through coursework, to recognize alcohol-related impairment conditions and determine a corresponding action.

20. The computer program product of claim 14, wherein the client is an establishment that serves alcohol to patrons, the program instructions further comprising providing, via a user interface, an option for tracking certification of employees of the establishment, and an option for requesting a driver service for a patron who is impaired.
